(19) United States
(12) Patent Application Publication
(10) Pub. No.: US 2006/0250332 A1
(43) Pub. Date: Nov. 9, 2006

(54) Data de-multiplexer and control method thereof

(75) Inventors: Shin-Tai Lo, Miaoli County (TW); Ching-Fu Hsu, Taichung County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/404,021

(22) Filed: Apr. 14, 2006

(30) Foreign Application Priority Data
Apr. 18, 2005 (TW) 094112177

(51) Int. Cl. G09G 3/30

(52) U.S. Cl. 345/76

(57) ABSTRACT

A data de-multiplexer and a control method thereof transmit plural image-data signals from an image-data driving element to a plurality of data lines of plural subpixels of a single pixel. The image-data signals time-sharing output to the data lines of the sub-pixels of the single pixel in sequence. Each of the data lines equips a sub-transmission circuit, and the sub-transmission circuits comprise plural switch paths that are controlled by a set of multiplex-control signal. By way of this, each image-data signal from the image-data driving element will transmit to the data line of the subpixel via the time-sharing conduction of the sub-transmission circuits in sequence.

### FIELD OF THE INVENTION

The present invention relates to a method for controlling the data signal, especially for the data signal of the display subpixel and uses the multiplex-signal control to form the data signal to be the multi-phase conduction path.

### BACKGROUND OF THE INVENTION

In recent years, the technology of a-Si thin film transistor (TFT) panels is making progress continuously, which includes the driving circuit design that is integrable on panels. Such as shift registers or data de-multiplexers that are composed of a-Si TFT elements. The a-Si TFT elements have the unstable phenomenon of the threshold voltage (Vth) shift easily when the bias stress is applied. As the working time increases, the extent of the threshold voltage (Vth) shift will seriously affect the normal operation of a shift register or a data de-multiplexer.

Traditionally, the data de-multiplexer built on the panel uses the technology of the LTPS TFT, as shown in FIG. 1. The characteristics of the data de-multiplexer are that each image signal from each image-data terminal will pass through three TFTs that are conducted time-sharing so that image-data signals time-sharing output to the three neighbor data lines in sequence. The three neighbor data lines control the three subpixels red (R), green (G), and blue (B) of each pixel on the display panel, and most of the switch TFTs of the data de-multiplexer are p-type LTPS TFTs.

For the purpose of conducting the switch TFTs time-sharing, there must be three multiplex-control signals, and the frequencies of the control signals equal to the scanning frequency of the display panel, i.e. the period is equal to the pulse width of the scanning signal) (1-H, the period of a horizontal signal). The effective working duty for each multiplex-control signal is ⅓, and the conduction periods of the multiplex-control signals are interlaced.

As shown in FIG. 2, the switches of the data de-multiplexer are built by a-Si TFTs. Most of a-Si TFTs are n-type, the three corresponding multiplex-control signals are shown in FIG. 3. Because the conduction frequency of the TFT is equal to the scanning frequency of the display panel and the effective working duty is ⅓, under these working conditions, the characteristics of a-Si TFT elements vary easily. Especially, the threshold voltage (Vth) of the TFT element will shift due to the above reason such that the impedance of the data de-multiplexer increases and the write-in response of the image-data signal will be slowed down. The display correctness of the image-data will be affected if the situation is serious such that the lifetime of the display panel is shortened.
a. Aim to this problem, U.S. Pat. No. 6,690,347 “Shift register and liquid crystal display using the same” (Feb. 10, 2004) proposed a scanning method that divided data lines into eight blocks. If the total number of the data lines of the panel is 528, there will be 66 data lines in each block. By controlling the built-in switch TFTs of each block, these eight blocks share the inputs of the 66 data signals so as to reduce the number of input lines and the cost of the driving element for the image data.

This control method makes that all switches formed by the a-Si TFT in each block are controlled by a multiplex signal respectively. By using eight independent multiplex-control signals to start the switch TFTs in each block in sequence, and input the image signals of each block in sequence. The frequencies of the eight independent multiplex-control signals equal to the scanning frequency of the display panel, i.e. the period is equal to the pulse width of the scanning signal. The effective working duty for each multiplex-control signal is ⅛, and the conduction periods of the eight multiplex-control signals are interlaced.

To Compare U.S. Pat. No. 6,690,347 with the aforementioned traditional method, because eight multiplex-control signals are used such that the effective working duty is reduced from ⅓ to ⅛ for the switch TFT. Accordingly, the threshold voltage shift of the a-Si TFT elements can be reduced, improved or eliminated so as to increase the stability and to extend the lifetime for the data de-multiplexer.

However, two drawbacks of U.S. Pat. No. 6,690,347 are resulted in:
1. The conduction time of the switch TFT of the data de-multiplexer is shortened. Therefore, the time for inputting the image-data voltage is also shortened. Take a panel with driving resolution 176×RGB×192 for example. The conduction time of the switch TFT by the aforementioned traditional method is 28 μsec approximately, whereas the conduction time of the switch TFT by U.S. Pat. No. 6,690,347 is reduced to 10 μsec. Consequently, for the purpose of completing the input of the image-data voltage in shorter time, the following items have to be noticed:
   (a) The driving ability of the driving element for the image data of the display panel has to be enhanced, while the cost of this kind of driving element for the image data is more expensive.
   (b) The impedance of the switch TFT of the data de-multiplexer has to be lower, i.e. the size of the switch TFT of the data de-multiplexer has to be larger. Moreover, the variation of the threshold voltage shift of the a-Si TFT elements has to be controlled within a lower range.
   (c) For every subpixel, the impedance of the switch TFT has to be lower and the size of the TFT has to be larger. As a result, it is disadvantageous to maintain the aperture rate of subpixels.
2. The working frequency of the switch TFT is still equal to the scanning frequency of the display panel. Although the effective working duty of the switch TFT is reduced, the high frequency is disadvantageous to the restraint of threshold voltage shift of a-Si TFT elements.

### SUMMARY OF THE INVENTION

The first purpose of the present invention is to provide a data de-multiplexer and a control method thereof. At the same time, the effective working duty of the switch transistor of the Data De-multiplexer is reduced, and the conduction time of the switch transistor will not be reduced. Moreover, that input time of image-data voltage will not be shortened.

The second purpose of the present invention is that at the same time, the effective working duty of the switch transistor of the Data De-multiplexer is reduced, and working frequencies of the switch transistors of the Data De-multiplexer will be reduced. The effective time of the negative-bias condition as cut-off of the switch transistor will be extended so that the negative-bias condition promotes the effect of restraining the threshold voltage shift of a-Si TFT elements to increase the stability and to extend the lifetime for the data de-multiplexer.

Another purpose of the present invention is to provide a data de-multiplexer and a control method thereof. Neither the driving ability of the image-data driving element has to be enhanced nor the size of the switch TFT in each subpixel has to be enlarged such that the aperture rate of the subpixel can be maintained.

The present invention is to dispose a data de-multiplexer between the image-data driving element and every data line of a plurality of subpixels. Then, each of the data lines equips a sub-transmission circuit, and the sub-transmission circuit is controlled by a multiplex-control signal.

The image-data signal from the image-data driving element time-sharing outputs to the data line that controls the subpixel. The image-data signals will be transmitted from the image-data driving element to the data line of the subpixel through the sub-transmission circuits by the time-sharing conduction. The sub-transmission circuits are composed of plural switch transistors that are connected in parallel. The switch TFTs are controlled by the plural multiplex signals such that the sub-transmission circuit of a data line exists only one conductive switch TFT at a time.

### BRIEF DESCRIPTION FOR THE DRAWINGS

FIG. 1 is the first schematic diagram for a traditional data de-multiplexer.

FIG. 2 is the second schematic diagram for a traditional data de-multiplexer.

FIG. 3 is the schematic diagram for the multiplex-control signals of FIG. 2.

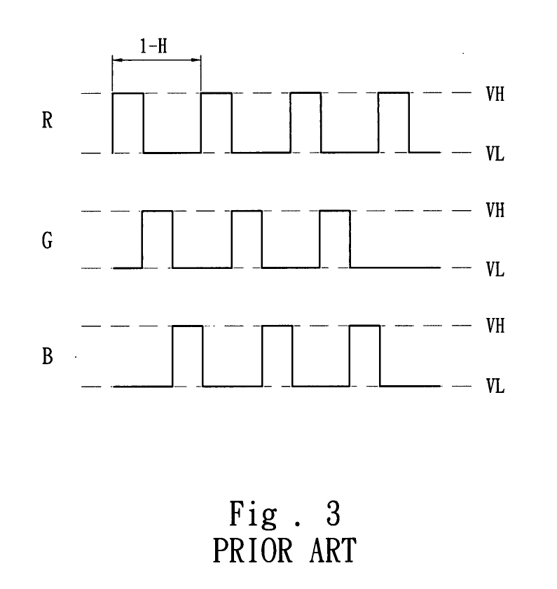

FIG. 4 is the schematic diagram for the data de-multiplexer of the present invention.

FIG. 5 shows the schematic diagrams for the internal circuits of the sub-transmission circuits RX, GX, and BX.

FIG. 6 is the first schematic diagram for the multiplex-control signals of the present invention.

FIG. 7 is the second schematic diagram for the multiplex-control signals of the present invention.

### DETAILED DESCRIPTION OF THE PREFERRED EMBODIMENT

The detailed descriptions for content and technology of the present invention associate with figures are as follows.

Every output of the image-data driving element was connected to the data line of the subpixel. The data de-multiplexer has a plurality of sub-transmission circuits and each sub-transmission circuit was equipped between the image-data driving element and the data line of the subpixel. The image-data signals from the image-data driving element time-sharing output to the neighbor data lines that control the subpixels. The sub-transmission circuits are plural switch paths, and each circuit is controlled by a set of multiplex-control signal. Thus, each image-data signal from the image-data driving element will be transmitted to the data lines of the subpixels in sequence by the time-sharing conduction of the sub-transmission circuits.

The sub-transmission circuits are composed of switch transistors that are connected in parallel. The switch TFTs are controlled by the corresponding plural multiplex signals such that the sub-transmission circuit of a data line of a subpixel exists only one conductive switch TFT at a time.

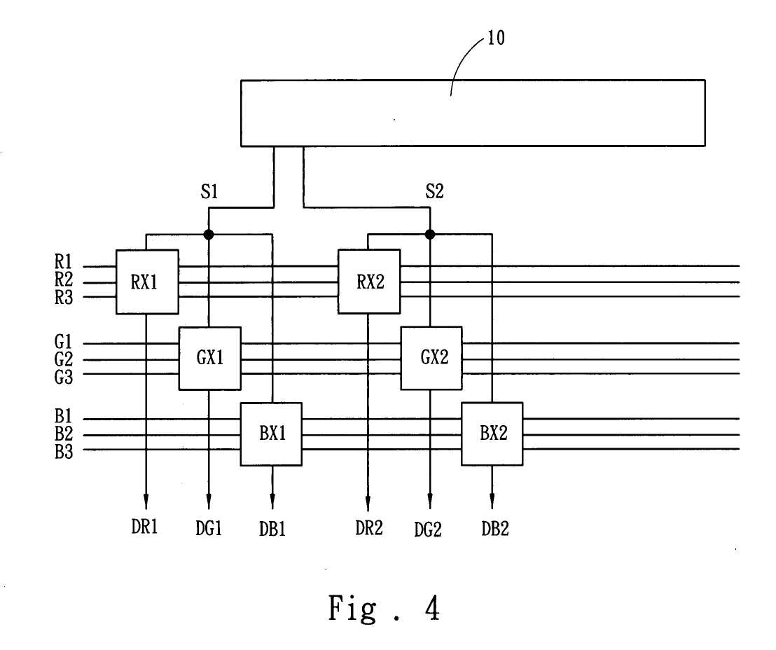

Please refer to FIG. 4, each output of the image-data driving element 10 will time-sharing output the image-data signals to the three neighbor data lines of the subpixels of the single pixel in sequence by the time-sharing conduction of the three sub-transmission circuits RX, GX, and BX (In this embodiment, the single pixel consists of three subpixels, which are red (R), green (G), and blue (B)). The three neighbor data lines control the three subpixels, red (R), green (G), and blue (B), of each single pixel.

For example, the image-data signals from terminal S1 (and S2) of the image-data driving element 10 will time-sharing output the image-data signals to the three neighbor data lines DR1, DG1, and DB1 (and DR2, DG2, and DB2) in sequence by the time-sharing conduction of the three sub-transmission circuits RX1, GX1, and BX1 (and RX2, GX2, and BX2).

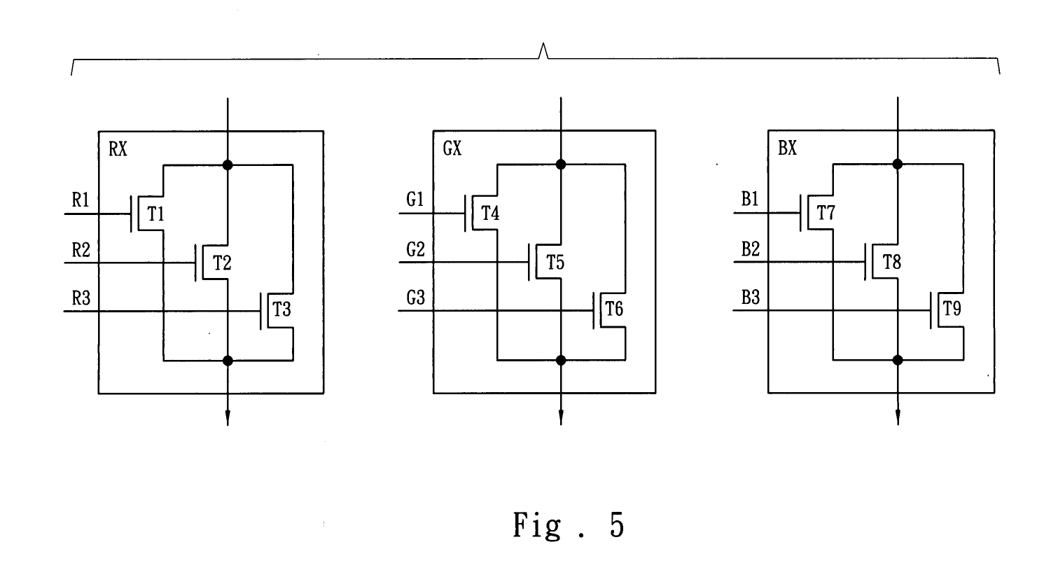

Please refer to FIG. 5, each internal circuit of the sub-transmission circuits RX, GX, and BX (RX1, GX1, BX1 and RX2, GX2, BX2) is composed of plural switch transistors (a-Si TFT) that are connected in parallel, i.e. there are plural a-Si switch TFTs connected in parallel between the input and the output. In this embodiment (the single pixel consists of three subpixels, which are red (R), green (G), and blue (B)), each of the sub-transmission circuits RX, GX, and BX consists of three switch transistors connected in parallel. The three switch transistors T1, T2, and T3 of the sub-transmission circuit RX are respectively controlled by the multiplex-control signals R1, R2, and R3; the three switch transistors T4, T5, and T6 of the sub-transmission circuit GX are respectively controlled by the multiplex-control signals G1, G2, and G3; the three switch transistors T7, T8, and T9 of the sub-transmission circuit BX are respectively controlled by the multiplex-control signals B1, B2, and B3.

Moreover, the ratio of the frequencies between the multiplex signal and scanning signal is equal to the reciprocal of the number of switch transistors of the sub-transmission circuit. Besides, the effective working duty of each multiplex-control signal equals the reciprocal of the total number of switch transistors of all the sub-transmission circuits included in the single pixel, and the effective working duties of the multiplex-control signals are staggered. For example, when the single pixel is composed of three subpixels, there are three sub-transmission circuits and the effective working duty of each multiplex-control signal equals the reciprocal of the total number of switch transistors of the three sub-transmission circuits.

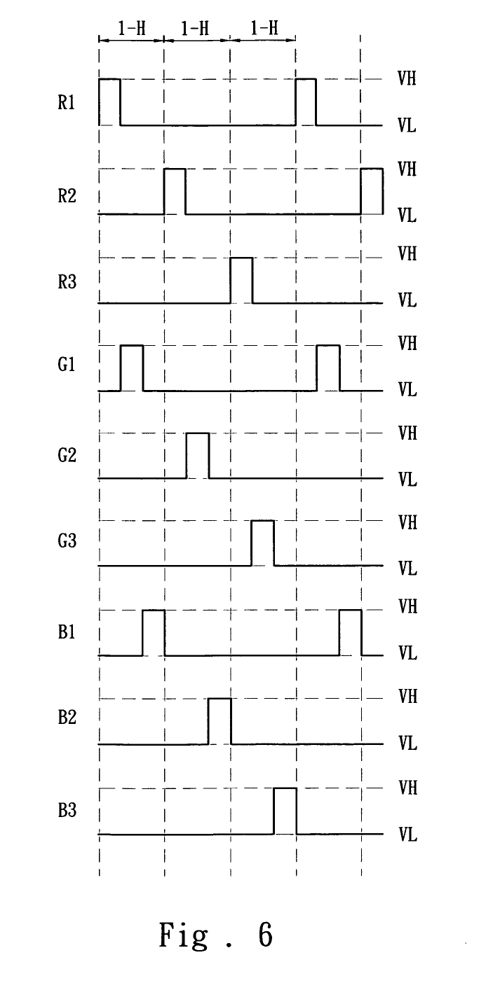

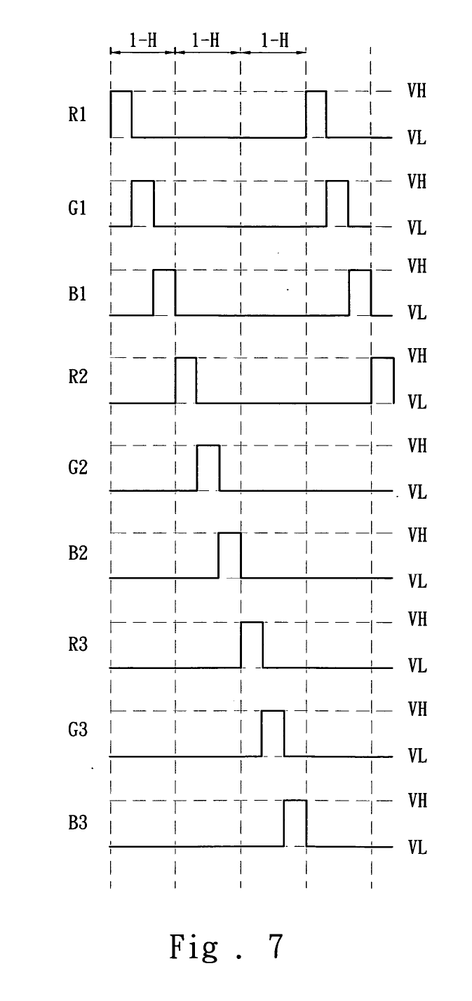

For this embodiment, the relations among the nine multiplex-control signals (R1, R2, R3, G1, G2, G3, B1, B2, and B3) are shown in FIG. 6. The frequencies of the multiplex-control signals are ⅓ of the scanning frequency of the display panel (because each sub-transmission circuit includes three switch transistors), i.e. the duty equals to the pulse width of three scanning signals (3-H, the duty of three horizontal signals). The effective working duty for each multiplex-control signal is 1/9, and the conduction periods of the nine multiplex-control signals are interlaced. The sequence is R1, G1, B1, R2, G2, B2, R3, G3, and B3, as shown in FIG. 7, which forms a Multi-Phase and Multi-Path control method. The image-data signals from the output terminal S1 (and S2) are input to the three subpixels, red (R), green (G), and blue (B), on data lines DR1, DG1, and DB1 (and DR2, DG2, and DB2) in sequence.

Each output of the image-data driving element 10 will time-sharing send the image-data signals to the data lines of the subpixels of the single pixel in sequence via the time-sharing conduction of the three sub-transmission circuits RX, GX, and BX. Each internal circuit of the sub-transmission circuits RX, GX, and BX is composed of plural a-Si switch TFTs that are connected in parallel. In conjunction with the control of plural multiplex signals, a model of Multi-phase plural conduction paths is thus formed. By way of the interlaced conduction method, the present invention is more suitable for the application of a-Si TFTs used as composed elements of a Data De-multiplexer.

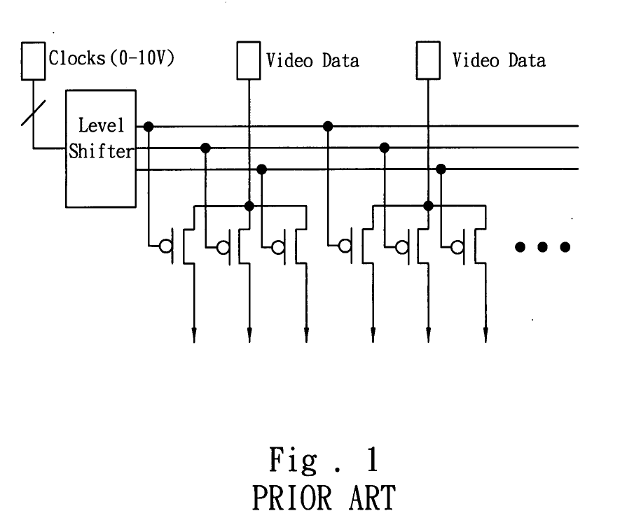

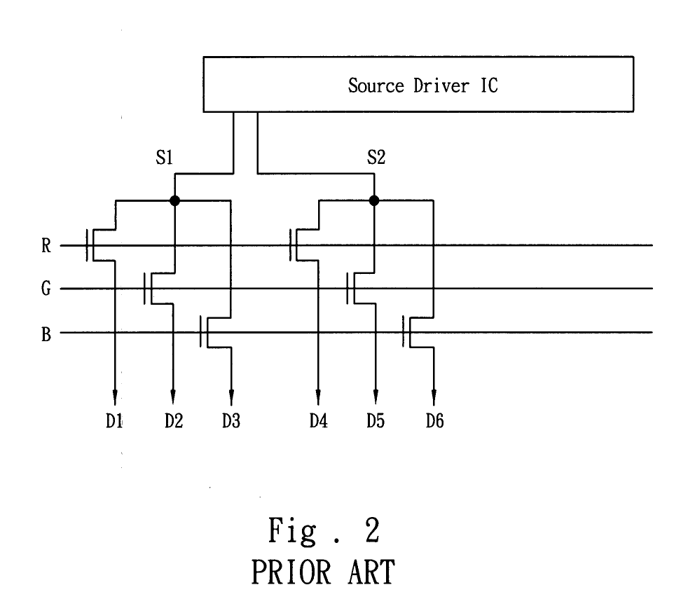

To compare the data de-multiplexer and its control method of this embodiment with the traditional Data De-multiplexer built on the panel (please refer to FIGS. 1 and 2), there are following features:
1. Because nine multiplex-control signals are used such that the effective working duty of the switch TFT is reduced from ⅓ to 1/9. Accordingly, the threshold voltage shift of the a-Si TFT elements can be reduced, improved or eliminated so as to increase the stability and to extend the lifetime for data de-multiplexer.
2. The present invention can avoid the two drawbacks of U.S. Pat. No. 6,690,347. (1) The conduction time of the switch transistor will not be reduced as the effective working duty of the switch transistor of the Data De-multiplexer is reduced. Moreover, that input time of image-data signal will not shorten at the same time. For example, for the panel with driving resolution 176×RGB×192, the conduction time of U.S. Pat. No. 6,690,347 is approximately 10 μsec whereas the conduction time of the present invention is approximately 28 μsec (as described in the aforementioned embodiment). (2) The working frequencies of the switch transistors of the Data De-multiplexer will reduce to ⅓ of the scanning frequency of the display panel (as described in the aforementioned embodiment). Therefore, to compare with U.S. Pat. No. 6,690,347, the present invention has the following merits:
   a. The driving ability of the driving element for the image data has not to be enhanced so as to avoid increasing the cost of the driving element.
   b. The impedance of the switch transistor of each subpixel has not to be lowered, i.e. the larger-size transistor is not necessary and the aperture rate of subpixels still can be maintained.
   c. At the same time, when the effective working duty of the switch transistor is reduced, and the working frequency is also reduced to ⅓ of the scanning frequency, so as to lengthen the effective time of the negative-bias condition for the switch transistor under cut-off such that the negative-bias condition promotes the effect of restraining the threshold voltage shift of a-Si TFT elements to increase the stability and to extend the lifetime for the data de-multiplexer.

To sum up, the data de-multiplexer and the control method that using Multi-Phase and Multi-Path for the present invention are more suitable for the application of a-Si TFTs used as composed elements of a data de-multiplexer. The data de-multiplexer and its control method can let the threshold voltage shift of the a-Si TFT elements of the multiplex switch reduce or eliminate so as to increase the stability of the data de-multiplexer and to relatively extend the lifetime of the panel.

However, the above description is only a better practice example for the present invention, which is not used to limit the practice scope of the invention. All equivalent changes and modifications based on the claimed items of the present invention are in the scope of the present invention.

What is claimed is:

1. A data de-multiplexer, for connecting a driving element and a plurality of data lines of a plurality of subpixels of a single pixel, comprising:
a plurality of sub-transmission circuits; and
each sub-transmission circuit being equipped between the driving element and each data line respectively and controlled by a set of multiplex-control signals.

2. The data de-multiplexer as claimed in claim 1, wherein the sub-transmission circuit is composed of plural switch transistors that are connected in parallel.

3. The data de-multiplexer as claimed in claim 1, wherein the switch transistors are amorphous silicon thin film transistors.

4. A control method for a data de-multiplexer, transmitting a plurality of image data signals of a driving element to a plurality of data lines of a plurality of subpixels of a single pixel, comprising:
each data line equipped a sub-transmission circuit;
the sub-transmission circuits being plural switch paths that each circuit is controlled by a set of multiplex-control signals; and
each image-data signal outputting to the data line by the time-sharing conduction of plural switch paths of the sub-transmission circuit.

5. The control method as claimed in claim 4, wherein the sub-transmission circuit is composed of a plurality of switch transistors that are connected in parallel.

6. The control method as claimed in claim 5, wherein the switch transistors are amorphous silicon thin film transistors.

7. The control method as claimed in claim 4, wherein the effective working duties of the multiplex-control signals are interlaced.

8. The control method as claimed in claim 4, wherein the ratio of the frequencies between each multiplex signal and the scanning signal is equal to the reciprocal of the number of switch transistors of the sub-transmission circuit.

9. The control method as claimed in claim 4, wherein the effective working duty of each multiplex-control signal equals the reciprocal of the total number of switch transistors of the sub-transmission circuits of the single pixel.
